(19) United States
(12) Patent Application Publication
(10) Pub. No.: US 2024/0375854 A1
(43) Pub. Date: Nov. 14, 2024

(54) Beverage Filter

(71) Applicants: Batdelger Khas, Skokie, IL (US); Maral Batdelger, Skokie, IL (US); Mergen Batdelger, Skokie, IL (US)

(72) Inventors: Batdelger Khas, Skokie, IL (US); Maral Batdelger, Skokie, IL (US); Mergen Batdelger, Skokie, IL (US)

(21) Appl. No.: 18/111,963

(22) Filed: Feb. 21, 2023

Related U.S. Application Data
(60) Provisional application No. 63/312,395, filed on Feb. 22, 2022.
(60) Provisional application No. 63/312,393, filed on Feb. 22, 2022.

(51) Int. Cl. B65D 85/804; A47J 31/00; A47J 31/06

(52) U.S. Cl. CPC B65D 85/8061; A47J 31/005; A47J 31/0626

(57) ABSTRACT

A beverage filter comprising a pocket portion and concentric skirt portion. The pocket portion is placed into a container while the concentric skirt portion engages the top and outer surface of the container to maintain the pocket portion suspended within the container's interior. The pocket portion may be filled with solute to be dissolved into the container. The skit portion may be sufficiently long so as to allow for the impermeable encapsulation of the pocket portion.

### BACKGROUND OF THE INVENTION

### Field of the Invention

The device relates to beverage preparation methods for indoor, outdoor, and commercial uses.

### Description of Relevant Prior Art

Beverage preparation does not have to be a big production. There are countless examples of attempts to simplify it and forgo the use of complicated and bulky electrical appliances; however, so far, none have been able to successfully establish this purpose. Instead, the devices produced thus far have been either too complicated, large, expensive, breakable, inefficient, require use of additional filters and other equipment, require cleaning, or can only be used indoors. The following provides a small overview of several examples that attempt to simplify beverage preparation methods; however, all of which have major limitations. They add to the preparation methods and create different complications that the current invention eliminated completely.

A first example is the BUNN 12-Cup Commercial Coffee Filters (https://www.amazon.com/1M5002-Commercial-Coffee-Filters-12-Cup/dp/B004NEWA1Q/ref=psdc_284507_t1_B07XGRY396?th=1). This is the traditional coffee filter used with coffee makers and other pour-over devices. It cannot be utilized on its own and requires being affixed onto a funnel or a filtration device on top of a cup or pot. Furthermore, it does not have an outer waterproof region to protects the edges of the vessel it is attached to, to protect it from water and solute spills.

A second example is the Deer Camp® (https://deercampcoffee.com/products/deer-camp-coffee-pour-over-coffee-filter-pouch-10-pk). This device attempts to create a disposable filtration pouch for single use. To use it, you affix it on top of a cup, fill it with a specific amount of coarse ground beans, and then slowly add water onto the ground beans. This contraption is affixed using plastic clamps that attach at the edge of a cup, these clamps extend from the filtration bag and hold the filtration bag in place.

Although, this disposable filtration device attempts to forgo the use of coffee filtration machines, it is not practical and has major flaws in its structure and design. First, because the plastic clamps are not flexible and cannot stretch far enough, it cannot accommodate different cup or pot sizes. Second, the filter size does not accommodate a higher (or varying) solute-to-solution ratios because of its small and fixed size. Third, it is not secure and does not prevent the accidental drop of solute into the beverage while adding water to the ground beans; thus, water must be added very slowly. Not to mention, that the slightest variation in its installment would most likely result in the collapse of the entire contraption. Two similar devices that have the same limitations are: Meraki Coffee Drip Bags (https://cafemerakicr.com/products/coffee-drip-bags), and Japanese Coffee Co. (https://japanesecoffeeco.com/blogs/japanese-coffee-blog/what-is-single-serve-disposable-filter-bag),

A third example is ZERO JAPAN Ceramic Coffee Dripper (https://www.amazon.com/dp/B0047VUNVE/?tag=thewire06-20&linkCode=xm2&ascsubtag=AwEAAAAAAAAAAYMs). This device is made of breakable ceramic and has a defined diameter that allows it to sit on fixed-size cups and pots. The coffee is placed in a filter on top of the device, the device is then affixed atop a cup, and water is then added to the coffee. This device cannot be used alone as it requires the use of additional filters to prepare coffee, and it requires constant cleaning.

A fourth example is the is Pour Over Coffee Maker, Pour Over Tea Dripper (https://www.amazon.com/Dripper-Borosilicate-Resistant-Stainless-Connoisseur/dp/B07WTN8YF5). This is a large, complicated contraption that comes with two glass vessels and a stand. It is expensive and requires a considerable amount of preparation, it is easily breakable and takes a lot of space. This contraption completely fails to simplify the tea preparation method; in fact, it makes it a longer and a more complicated process.

A fifth example is the PURE OVER DRIPPER SET (https://pureover.com/products/pure-over-dripper?currency=USD&utm_medium=product_sync&utm_source=google&utm_content=sag_organic&utm_campaign=sag_organic&gclid=Cj0KCQjw08aYBhD1ARIsAA_gb0fRwC_P0a8iLJ1Oa4vuA1M8btwjf5nKPcbmWY-jCY-v5w-KSMAYWtoaArIIEALw_wcB&variant=37647248162975). This device is an expensive, handheld glass filter that requires a lot of preparation time. It does not simplify the beverage preparation method, nor does it make it more convenient. It necessitates the use of cups and pots of certain sizes to accommodate the circumference of its base. It is made of breakable glass, and it is hard to pack and move. Thus, it cannot be used on the go or outside the house.

A sixth example is the Chemex Pour-Over Glass Coffemaker (https://www.amazon.com/dp/B0000YWF5E/?tag=thewire06-20&linkCode=xm2&ascsubtag=AwEAAAAAAAAAAYMt). This device is made of glass, it is a funnel connected to a pot. A filter must be fixed to the funnel before the ground coffee beans are added. After adding the water to the coffee solute and filtering the solution into the pot, the filter must be removed, and the coffee solution is then poured into a different cup. This device is relatively expensive, breakable, and requires filters; all of which does not simplify beverage preparation. The device is not realistically portable and cannot be taken on road trips or the outdoors.

From the foregoing, it is clear that while beverage preparation and filtration method are widely used to prepare coffee, tea, etc.; no one has been able to truly simplify this method. The present invention combines the simplicity of usage, the ease of transferability, cost effectiveness, and sturdiness, all while eliminating the need to use complicated vessels and complicated assemblies. This device allows you to enjoy a quality brew every day and anywhere at a very affordable price.

### BRIEF SUMMARY OF THE INVENTION

The device comprises at least two parts: a pocket portion and a concentric skirt portion. It is an all-in-one pour-over device that does not require the use or assist of any other implement or machine to fully preform its function. Its simplicity allows it to be used anywhere: whether at home, on the go, in a dorm room, or in commercial shops. It is ideal for hosting a group of people with varying tastes and brew preferences, because all that is required is a large pot of water and the ingredients to make each person his or her favorite beverage. The device can accommodate a wide range of vessel designs and sizes. It is perfect for kitchenettes, small kitchens, dorm rooms, road trips, and commercial shops. It can create cold brews, drip coffee, tea, cocoa, and many other beverages. No cleaning is required, and no additional filters or contraptions are needed.

The pocket portion consist of at least one wall that extends from a floor. The pocket portion is a filter that would house the solute. The solute can be any type of ground coffee beans, tea leaves, cocoa powder, etc. The concentric skirt portion is the part of the device that goes over the edge of a vessel and holds it securely over the vessel. The skirt portion can be waterproof which help protects the vessel from being soiled by the solute and solution; it also prevents the solute from inadvertently falling into the solution during preparation.

The Beverage Filter can be ideal for bulk manufacturing of pre-packaged solute packets. This is done by creating an airtight chamber around the pocket portion using the skirt portion. The sealed, airtight chamber allows the preservation of the solute and guarantees the freshness of its ingredients.

### BRIEF DESCRIPTION OF THE DRAWINGS

The Accompanying figures and drawings, incorporated into, and forming part of the specification, service to further illustrate the present invention, its various principles and advantages, and its varying embodiments:

FIG. 1 is a side view of the device affixed to a container.

FIG. 2 is a side view of the device affixed to a container.

FIG. 3 is a side view of the device affixed to a container.

FIG. 4 is a side view of a closed, airtight configuration of the device.

FIG. 5 is a side view of the closed configuration being mounted onto the container.

FIG. 6 is a side view of the device affixed to a container with a handle.

FIG. 7 is a side view of the device with opening to accommodate container handle and a hole on the cusp for an observer to monitor solution level.

FIG. 8 is a ventral view of an exemplary beverage filter, according to the disclosure herein.

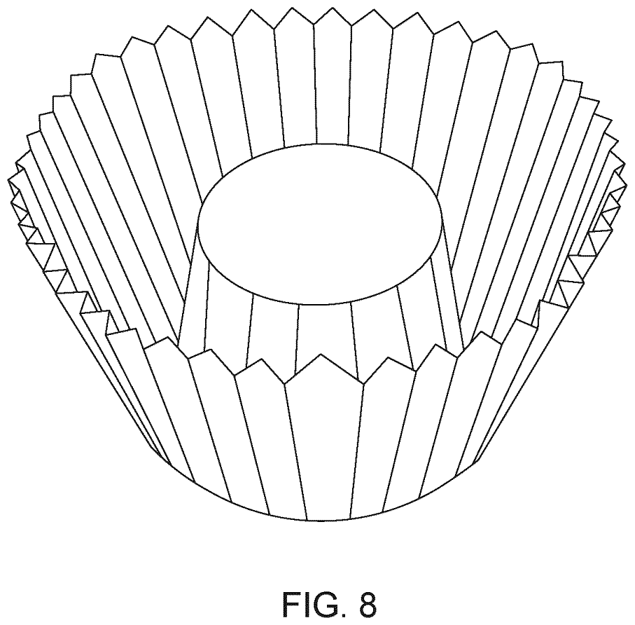

FIG. 9 is front perspective view of an exemplary beverage filter, according to the disclosure herein.

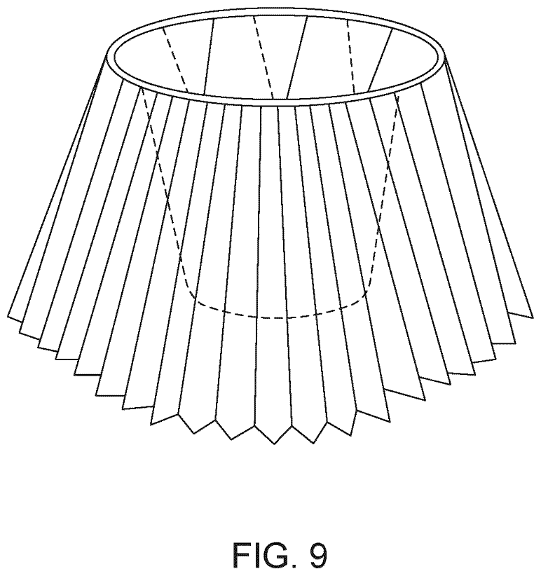

### DETAILED DESCRIPTION OF THE INVENTION

Provided is a device that filters beverages in an easy, simple way without requiring the use or assistance of an additional contraption. The device comprises a pocket portion and a skirt portion.

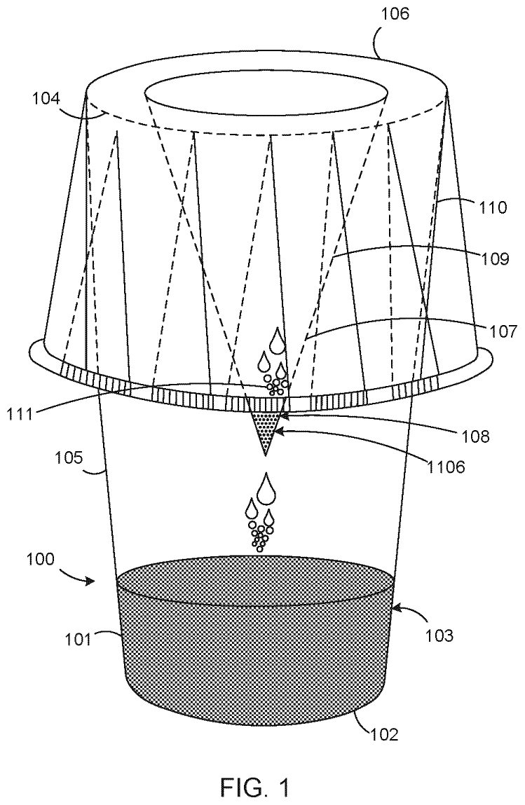

FIG. 1 illustrates a side view of the filter 106 affixed on top of a container 100. The container 100 consists of a base 102, a rim 104, and an outer surface 106. The container 100 can hold a quantity of liquid (e.g., water) 101. The filter 106 consists of a pocket portion 107 and a concentric skirt portion 110. The pocket portion 107 consists of a floor 108, and a wall 109.

When the filter 106 is aligned on top of the container 100 the pocket portion 107 should fits within the container 100 through the rim 104. The filter 106 rests on the container 100 against the rim 104 of the container 100.

A desired amount of a solute 1106 (whether it is coffee, tea, cocoa, or any other desired solute) is placed in the pocket portion 109, and a solvent 111 is poured over the solute 1106. The solvent 111 can be hot or cold, it can be water, milk, or any other desired liquid. After pouring the solvent 111 over the solute 1106 a solution 101 is created and can filter through the wall 109 and the floor 108 of the conical pocket portion 107 to the base 102 of the container 100. The amount and ratio of solute 1106 to solvent 111 can be adjusted based on the taste and the desired strength, tincture, amount, and other consideration that a person is looking for in their favorite beverage.

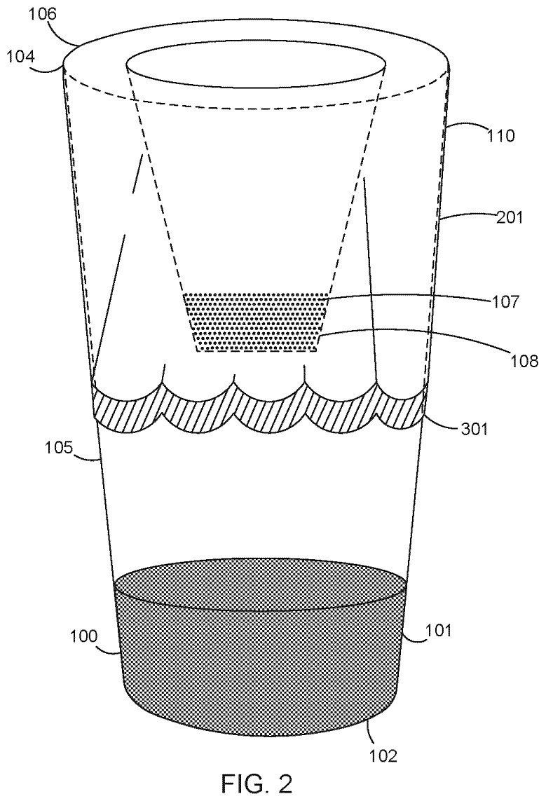

FIG. 2 illustrates an alternate embodiment of the invention. A filter 106 is placed into a container 100. The filter 106 has a skirt portion 110, a length of which 201 is fixably foldable so that it can be pressed against the rim 104 outer surface 105 of the container 100. This grips the filter 106 against the container 100 to help maintain the pocket portion 107 and its floor well above the base 102 of the container 100 and to accommodate the forthcoming solution 101. Alternatively, or additionally, the fluted skirt portion 110 may comprise an elastic member 301, at any region or length of the filter 106, which provides additional purchase against the outer surface 105 to help maintain the pocket portion 107 within the container 100.

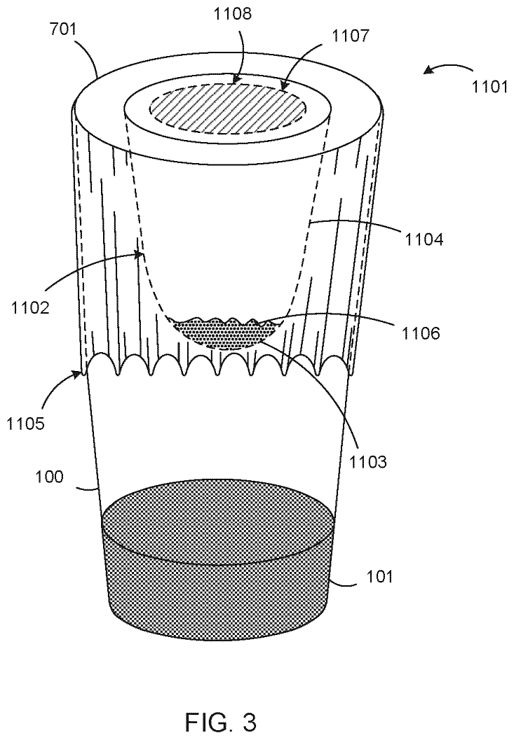

FIG. 3 illustrates an alternate embodiment of the invention. A filter 1101 is placed into a container 100. The filter 1101 comprises a pocket portion 1102, the pocket portion having a floor 1103 and a wall 1104. A cusp region 701 exists between a concentric pleated skirt portion 1105 of the filter 1101 and the pocket portion 1102. A cap member 1107 exists over the top of the pocket portion 1102 to contain soluble material 1106. The cap member 1107 has a permeable region 1108 that allows a liquid (e.g., water) to pass through and into the pocket portion 1102 and onto the soluble material 1106, creating a solution 101. The cap member 1107 may alternatively be impermeable (e.g., airproof and waterproof) to protect the soluble material 1106 from the atmosphere. The skirt portion 1105 is corrugated to enhance rigidity.

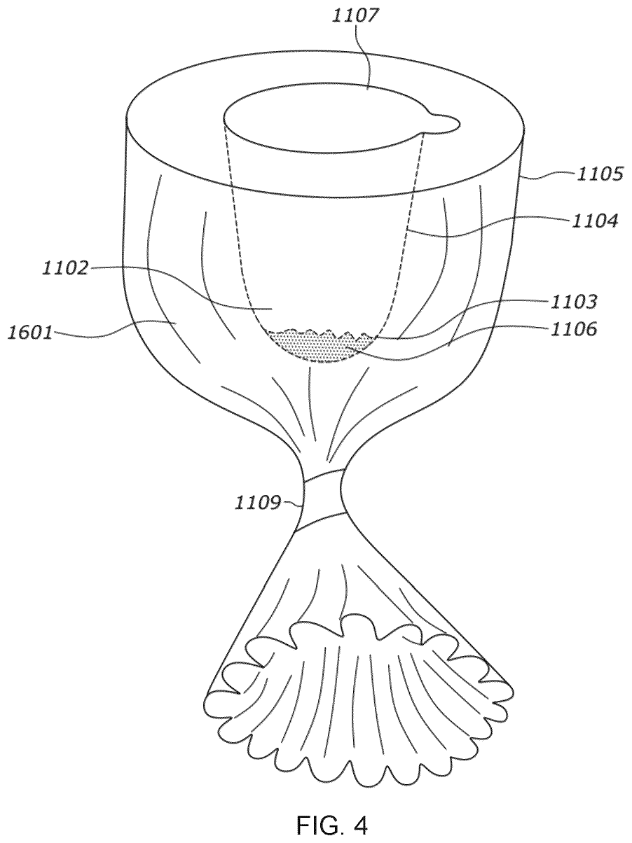

FIG. 4 illustrates an alternate embodiment of the invention in an undeployed configuration. The filter 1101 comprises a pocket portion 1102 that has a floor 1103 and a wall 1104. The filter has a concentric skirt portion 1105 that is impermeable and which extends from termination of the pocket portion. The skirt portion 1105 extends substantially past the floor 1103 of the pocket portion such that the skirt portion can be secured against itself with a tie 1109 or other fastening means. A cap member 1107 that is both impermeable and removeable exists over the pocket portion 1102. In this configuration, the soluble materials 1106 is maintained in an airtight state, despite the pocket portion being porous. The pocket portion is sealed within an airtight chamber 1601 within the impermeable skirt portion 1105 and, prior to being used, the impermeable cap member 1107.

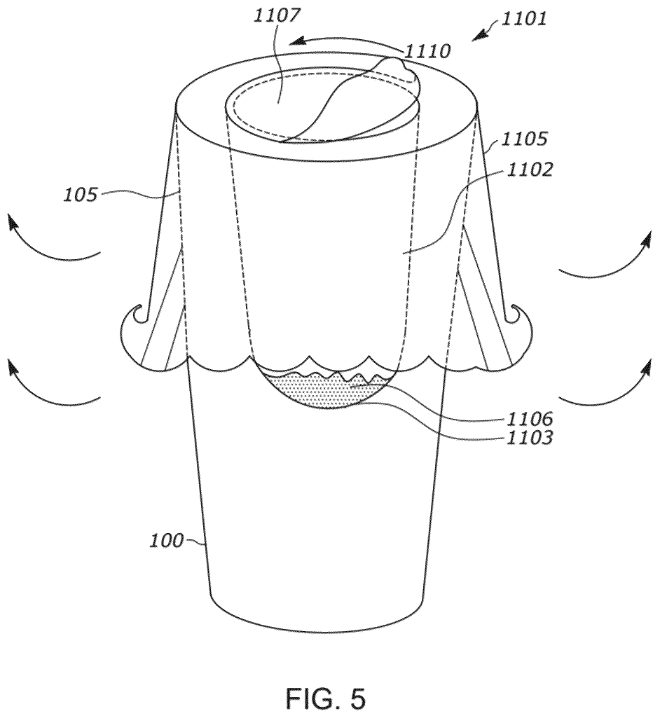

FIG. 5 illustrates an alternate embodiment of the invention in deployed configuration. The skirt portion 1105 of the filter 1101 is released and folded up exposing the pocket portion 1102. The pocket portion 1102 is placed into a container 100. The skirt portion 1105 is secured against the outer surface 105 of the container 100, keeping the floor 1103 of the pocket portion suspended in the container 100. The impermeable cap member 1107 is removeable 1110, allowing access to the soluble material. A solvent (e.g., water) may be poured into the pocket portion, creating a solution which escapes through the pocket portion and into the container 100.

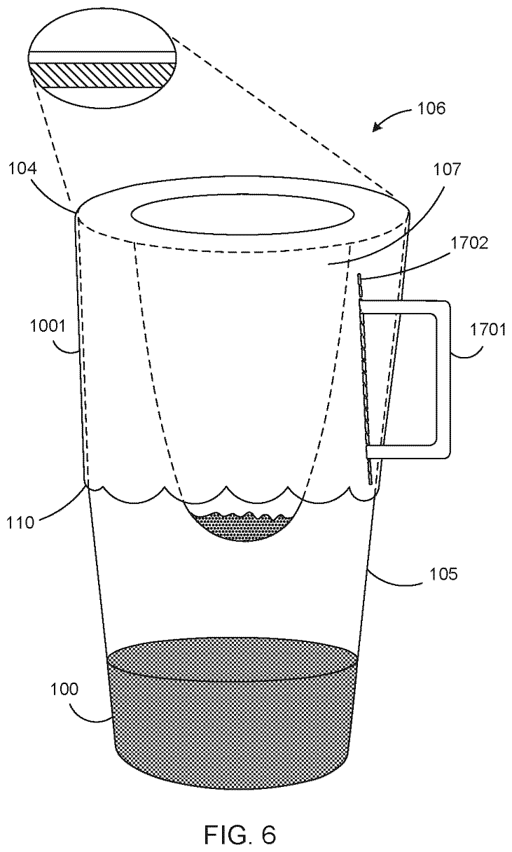

FIG. 6 illustrates an alternate embodiment of the invention. A container 100 has a handle 1701 extending from the outer surface 105 of the container 100. A filter 106 having a pocket portion 107 is placed into the container 101 and the filter rests on the rim 104 of the container 100. The filter 106 has a skirt portion 110, the skirt portion having a series of perforations 1702. The skirt portion 110 is supported by a deformable layer 1001 of aluminum foil that remains sufficiently rigid to help maintain the pocket portion 107 within the container, and upon doing so the skirt portion splits along the perforations 1702 to accommodate the handle 1701.

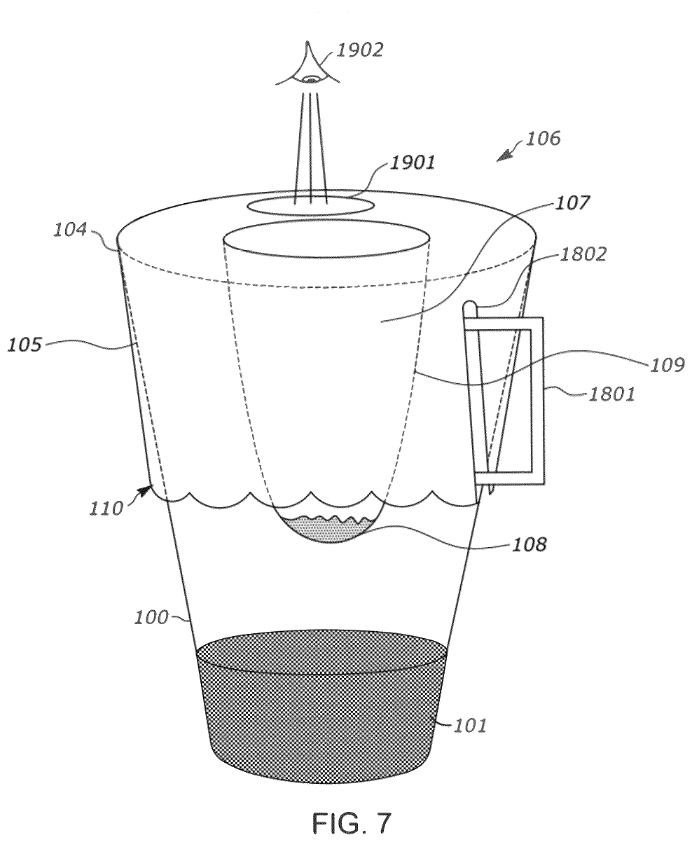

FIG. 7 illustrates an alternate embodiment of the invention. A container 100 has a handle 1801 extending from the outer surface 105 of the container. A filter 106 comprises a pocket portion 107 having a floor 108 and a wall 109. A cusp region 701 exists between the wall 109 of the pocket portion 107 and the skirt portion 110 of the filter 106. A hole 1901 exists on the cusp region 701 to allow for a user to see 1902 the contents of the container 100, including the solution 101 which the user is making. The skirt portion 110 contains an opening 1802 to accommodate the handle 1801 that extends from the outer surface 105. The skirt portion can be fixably folded onto the outer surface 105, wherein the pocket portion 107 is suspended in the container 100 and the handle 1801 is accessible by the user and not obscured by the filter 106.

The filter may be made from media such as paper, wood, stainless steel, linen, cotton, and nylon which help ensure that the solution—coffee, tea, or other beverages—produced by the invention has the cleanest and truest flavor. Media having an average pore diameter of between 4 and 1000 μm may be optimal to preventing the escape of particulates from the soluble material.

Aluminum foil or other deformable materials may be adhered to the filter in or around the skirt portion to help maintain the rigidity of that region of the filter to help prevent the pocket portion from falling into a container once the filter with soluble material is placed into the container and a solvent (e.g., water) is poured into the pocket portion. The filter media may be corrugated, fluted, or pleated to improve the media's rigidity and help suspend the pocket portion into a container and above the solution being filtered through the pocket portion.

While invention and methods of use thereof have been described with reference to certain embodiments, various modifications thereof will be apparent to those skilled in the art without departing from the scope of the invention.

We claim:

1. A beverage brewing device comprising:
a container that holds a quantity of water, the container having a base and at least one side extending up from the base, the at least one side terminating in a rim, the at least one side having an outer surface;
a filter, the filter comprising a pocket portion, the pocket portion having a floor and at least one wall extending up from the floor, the at least one wall terminating in a concentric skirt portion, the filter adapted for the pocket portion to be placed into the container;

2. The beverage device of claim 1, wherein a length of the skirt portion is fixably foldable upon the outer surface of the container to maintain the floor of the pocket portion above the base of the container.

3. The beverage device of claim 1, wherein the skirt portion contains an elastic member, wherein the elastic member secures the skirt portions against the outer surface of the container to maintain the floor of the pocket portion above the base of the container.

4. The beverage device of claim 1, wherein the floor of the pocket portion has a conical shape.

5. The beverage device of claim 1, wherein the skirt portion is pleated.

6. The beverage device of claim 1, wherein a cusp region exists between the at least one wall of the pocket portion and the skirt portion, the filter being adapted for the pocket portion to be placed into the container where the cusp region rests atop the rim.

7. The beverage device of claim 1, wherein the filter is made of a material selected from a group consisting of aluminum, paper, wood, stainless steel, linen, cotton, polypropylene, high-density polyethylene, silicone, and nylon.

8. The beverage device of claim 7, wherein the filter further comprises pores, the pores having an average diameter of between 4 and 1000 μm.

9. The beverage device of claim 1, wherein the skirt portion further comprises a deformable layer.

10. A filter, the filter comprising a pocket portion, the pocket portion having a floor and at least one wall extending up from the floor, the at least one wall terminating in a concentric skirt portion, the pocket portion containing an amount of soluble material, the filter further comprising a cap member is secured over the pocket portion.

11. The filter of claim 10, wherein the cap member is porous to allow water to pass through.

12. The filter of claim 10, wherein the cap member is removable from the filter.

13. The filter of claim 10, wherein the cap member is airproof.

14. The filter of claim 10, wherein the skirt portion is airproof.

15. The filter of claim 10, wherein the skirt portion has a radius sufficient to allow for the skirt portion to be folded under the pocket portion and collected against itself to form an airtight chamber around the pocket portion.

16. The beverage device of claim 1, wherein the container further comprises a handle on its outer surface, wherein the skirt portion further comprises a series of perforations to cause the skirt portion to tear when pressed against the handle.

17. The beverage device of claim 2, wherein the container further comprises a handle on its outer surface, wherein the skirt portion further comprises an opening to accommodate the handle when the skirt portion is folded over the outer surface of the container.

18. The beverage device of claim 6, wherein the cusp region comprises at least one hole to allow viewing into the container when the pocket portion is placed into the container.

19. The beverage device of claim 1, wherein the skirt portion is corrugated.

20. The beverage device of claim 1, wherein the pocket portion and skirt portion are each made from a different material selected from a group consisting of aluminum, paper, wood, stainless steel, linen, cotton, polypropylene, high-density polyethylene, silicone, and nylon.

21. The beverage device of claim 1, wherein the concentric skirt portion terminates in a rounded fold.
